(19) United States
(12) Patent Application Publication
(10) Pub. No.: US 2024/0395080 A1
(43) Pub. Date: Nov. 28, 2024

(54) SYSTEMS AND METHODS OF DISPLAYING DRIVING DATA USING TELEMATICS DATA

(71) Applicant: Allstate Insurance Company, Northbrook, IL (US)

(72) Inventors: Daniel Brian MOHNEN, Grayslake, IL (US); Michael Aaron Judy, Northbrook, IL (US)

(21) Appl. No.: 18/200,083

(22) Filed: May 22, 2023

(51) Int. Cl. G07C 5/02; B60W 40/10; B60W 50/14

(52) U.S. Cl. CPC G07C 5/02; B60W 40/10; B60W 50/14; B60W 2050/0005; B60W 2510/18; B60W 2530/18; B60W 2540/041

(57) ABSTRACT

Implementations claimed and described herein provide systems and methods for generating a display of driving data using telematics data. The systems and methods use telematics data generated via a telematics device disposed in a vehicle. One or more driving attributes associated with a vehicle operator and/or the vehicle based on the telematics data are determined by the system. The one or more driving attributes associated with the vehicle operator and/or the vehicle are compared to one or more driving attributes associated with one or more connected users, where the one or more driving attributes associated with one or more connected users are received from one or more databases. Furthermore, a user interface is generated that presents a result of the comparison.

### FIELD

Aspects of the presently disclosed technology relate generally driving data based on telematics data. More specifically, aspects of this disclosure relate to systems and methods for capturing, comparing, and communicating driving data based on telematics data to encourage safe driving behavior.

### BACKGROUND

People and organizations, such as auto-insurance companies or providers, may collect and/or analyze vehicle telematics data for a variety of purposes. Vehicle telematics data includes various data from measurements related to a vehicle's operation. For example, vehicle telematics data may include global positioning system (GPS) coordinates of an automobile that allow the location of the automobile to be tracked. Also, for example, vehicle telematics data may include acceleration data of an automobile that allows the speed of the automobile to be tracked. Insurance providers may use this information, in some examples, to evaluate the risk of customers and potential customers. Other organizations may also be interested in such information to determine a person's driving behavior. Moreover, drivers, parents or other guardians of drivers, insurance providers, and the like, may desire to use this data to encourage safe driving behaviors.

However, users rarely look at their driving data. As such, driving data communicated by conventional systems do not effectively encourage safe driving behavior. It is with these observations in mind, among others, that various aspects of the present disclosure were conceived and developed.

### SUMMARY

Implementations described and claimed herein address the foregoing problems by providing systems and methods for displaying driving data using telematics data. For instance, a computer implemented method can comprise: receiving telematics data generated by a telematics device disposed within a vehicle; determining one or more driving attributes associated with the vehicle based on the telematics data; comparing the one or more driving attributes associated with the vehicle with one or more driving attributes associated with one or more connected users, the one or more driving attributes associated with one or more connected users received from one or more databases; and generating data to cause a user interface to be generated presenting a result of the comparing.

In some implementations, a system comprises at least one processor configured to: determine telematics data generated using a telematics device disposed within a vehicle; determine one or more driving attributes associated with at least one of a vehicle operator or the vehicle based on the telematics data; compare the one or more driving attributes associated with the at least one of the vehicle operator or the vehicle to one or more driving attributes associated with one or more connected users, the one or more driving attributes associated with one or more connected users received from one or more databases; and cause a user interface to be generated that presents a result of the comparison.

In some instances, one or more tangible non-transitory computer-readable storage media store computer-executable instructions for performing a computer process on a computing system, the computer process comprising: receiving telematics data generated by a telematics device disposed within a vehicle; determining one or more driving attributes associated with a specific individual operating the vehicle based on the telematics data; comparing the one or more driving attributes associated with the specific individual operating the vehicle to one or more driving attributes associated with one or more connected users, the one or more driving attributes associated with one or more connected users received from one or more databases; and causing a user interface to be generated presenting a result of the comparing.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system to generate a driving behavior assessment using different types of telematics data.

FIG. 2 illustrates an example system to generate a driving behavior assessment using different types of telematics data to determine driving attributes.

FIG. 3 illustrates an example system to generate a driving behavior assessment using different types of telematics data and one or more computing devices.

FIG. 4 illustrates an example method to generate a driving behavior assessment using different types of telematics data.

### DETAILED DESCRIPTION

Aspects of the present disclosure involve systems and methods to generate a display of driving data using telematics data. The systems and methods described herein use telematics data generated by telematics device(s) to determine driving attributes that can be compared to an aggregate of connected user(s) driving attributes to provide more comprehensive data related to driving behavior. This results in more user friendly information that can be communicated to a user to influence safe driving behavior of the user. Additional advantages of the presently disclosed technology will become apparent from the detailed description below.

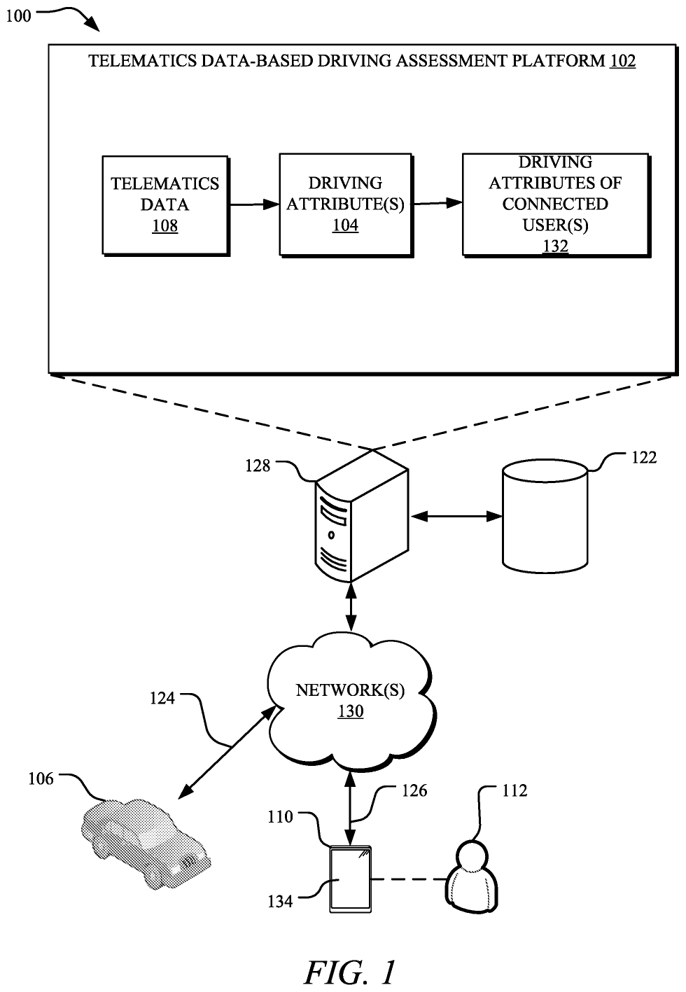

To begin a detailed description of an example system 100 to display driving data using telematics data, reference is made to FIGS. 1-4. The system 100 can include a telematics data-based driving assessment platform 102. The telematics data-based driving assessment platform 102 can receive multiple, different types of telematics data 108 regarding a vehicle 106 from different data sources using different types of data connections. Upon receiving the telematics data 108, the telematics data-based driving assessment platform 102 can perform operations to transform the different types of telematics data 108 into driving attributes 104.

The vehicle 106 can be, for example, an automobile, motorcycle, scooter, bus, recreational vehicle, boat, or other vehicle for which sensor or crash data can be collected and analyzed. A telematics device disposed within the vehicle 106 can be used to collect and/or receive sensor data and/or to receive sensor data from the vehicle 106. The telematics device can process the data to detect a crash or non-crash event and/or transmit the sensor or crash data to the telematics data-based driving assessment platform 102 or other computing devices. The telematics device can be a computing device of the vehicle 106 or one or more mobile computing devices 110, for example, mobile phones, personal digital assistants (PDAs), tablet computers, laptop computers, smartwatches, and other devices that can be carried by drivers or passengers inside or outside of the vehicle 106. The telematics device can also be integrated into the vehicle 106 and/or connected to a data bus within the vehicle 106 via an on-board diagnostics (OBD) device installed in a vehicle 106, such as, an OBD-II device that can generate data corresponding to various OBD parameter IDS (OBD-II PIDs) which can be defined by Society of Automotive Engineers (SAE) standards.

The telematics device can receive a variety of data, such as acceleration, velocity, location, vehicle operation data such as braking, turning, swerving, and the like from vehicle sensors located within the telematics device and/or vehicle 106. The vehicle sensors can include fuel level sensors, tire pressure sensors, engine temperature sensors, a global positioning system (GPS) sensor, a global navigation satellite system (GNSS), an onboard computer tracking systems, etc. Additionally or alternatively, the telematics data 108 can originate and/or be received from the one or more mobile computing devices 110 associated with a specific individual 112. Additionally or alternatively, the telematics device includes a Global Positioning System (GPS) receiver that can determine vehicle location, speed, direction and other basic driving data without needing to communicate with the vehicle sensors or external vehicle systems. However, it should be noted that any of a variety of other location determination techniques, such as location determined based on wireless networks to which the one or more mobile computing devices 110 is connected, such as Wi-Fi networks, cellular networks, and the like, can also be used. The sensors of the telematics device, such as a GPS and/or a compass, can sense the speed and/or direction at which the telematics device (and accordingly vehicle 106) is traveling. An accelerometer of the telematics device can sense the acceleration of the mobile device. A gyroscope can be used to determine the orientation of the mobile device. In some aspects, orientation can be detected, for example, at a rate of 90 Hz. The gyroscope can also be used to measure the speed of rotation of the telematics device. A magnetometer can be used to measure the strength and direction of the magnetic field relative to the telematics device. The data collected by the telematics device can be stored and/or analyzed within the telematics device. The processing components of the telematics device can be used to analyze sensor data, determine that a crash has or has not occurred, and confirm whether or not the crash has occurred. Additionally or alternatively, the telematics device can transmit, via a wired or wireless transmission network, the data to one or more computing devices for storage and/or analysis. In a variety of embodiments, the telematics device transmits data when it detects that a crash has occurred.

In an implementation, the telematics data 108 includes acceleration data 114, braking data 116, location data 118, and/or speed data 120. The telematics data 108 can be transmitted to the telematics data-based driving assessment platform 102 on a rolling basis, on a batch basis (e.g., every month, every six months, every 12 months, etc.), responsive to a consumer or interface call for data, response to an interface requesting data in response to detecting consumer activity, or the like. The telematics data-based driving assessment platform 102 can receive and/or store the telematics data 108 with the associated timestamps at one or more databases 122. Values of the acceleration data 114, braking data 116, location data 118, and/or speed data 120 can be extracted from the telematics data 108. The telematics data 108 can be associated with the vehicle 106 independently from any associations with the specific individual 112, and/or the telematics data 108 can be associated with both the vehicle 106 and the one or more mobile computing devices 110 associated with the specific individual 112 operating the vehicle 106 at the time the telematics data 108 is generated (e.g., by using a Bluetooth sync, a trip match with a previous trip start or trip end point, or the like).

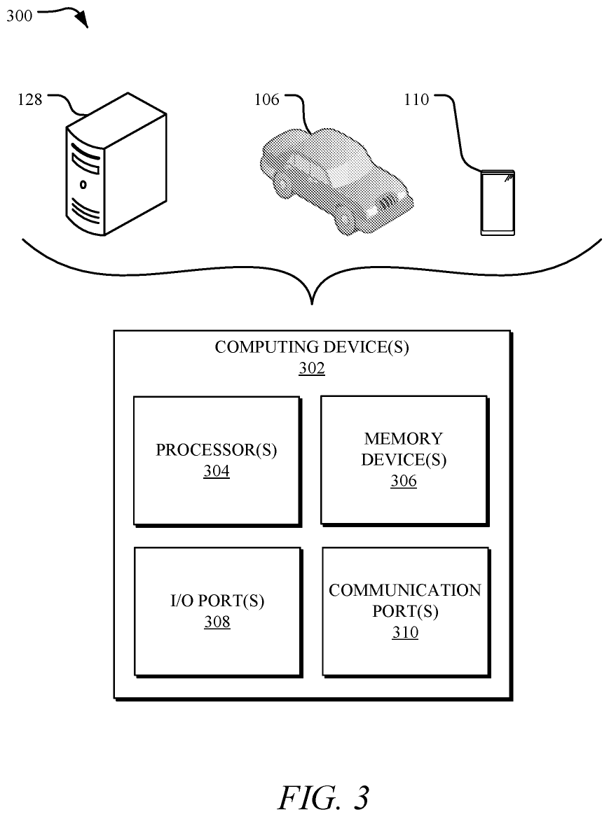

In an implementation where the telematics data 108 is generated and/or sent from the one or more mobile computing devices 110 associated with the specific individual 112 while the specific individual 112 is operating the vehicle 106. An application operating on the one or more mobile computing devices 110 can use the various sensor and hardware components of the one or more mobile computing devices 110 to generate and/or send the telematics data 108 to the telematics data-based driving assessment platform 102. In some instances, the application is received at the one or more mobile computing devices 110 from the telematics data-based driving assessment platform 102 (e.g., via an application store) in response to a request to join a driving assessment program or procedure (e.g., as part of an onboarding process). The telematics data 108 can include data generated using a global positioning system (GPS) sensor, an accelerometer sensor, a camera, a microphone, or any other components of the one or more mobile computing devices 110 (e.g., which are discussed in greater detail below regarding FIG. 3). As such the telematics data 108 can be formatted to correspond to an operating system of the one or more mobile computing devices 110 (e.g., iOS®, Android®, etc.). The telematics data 108 can be timestamped and/or associated with the specific individual 112 based on the association between the specific individual 112 and the one or more mobile computing devices 110.

The telematics data-based driving assessment platform 102 can receive the telematics data 108 by way of one or more of a first connection 124 between the telematics data-based driving assessment platform 102 and the vehicle 106 (e.g., formed by an OBD device) and a second connection 126 between the telematics data-based driving assessment platform 102 and the one or more mobile computing devices 110. The first connection 124 and the second connection 126 can be established using the respective communication ports of the vehicle 106 and the one or more mobile computing devices 110 discussed below regarding FIG. 3. For instance, the first connection 124 and the second connection 126 are established with one or more server device(s) 128 hosting and/or executing the telematics data-based driving assessment platform 102 via one or more network(s) 130. The network(s) 130 can be any combination of one or more of a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 130 can include any type of network, such as the Internet, an intranet, a Virtual Private Network (VPN), a Voice over Internet Protocol (VOIP) network, a wireless network (e.g., Bluetooth), a cellular network, a satellite network, combinations thereof, etc. The network(s) 130 can provide access to and interactions with the telematics data-based driving assessment platform 102 for the telematics device. The network(s) 130 can include communications network components such as, but not limited to gateways routers, servers, and registrars, which enable communication across the network(s) 130. In one implementation, the communications network components include multiple ingress/egress routers, which may have one or more ports, in communication with the network(s) 130.

Furthermore, the server device(s) 128 operating the telematics data-based driving assessment platform 102 can include at least one server device 128 hosting software, application(s), websites, and the like for receiving the telematics data 108, storing this data at the one or more databases 122, and/or analyzing this data to generate the driving behavior assessment. The server device(s) 128 may be a single server, a plurality of servers with each such server being a physical server or a virtual machine, or a collection of both physical servers and virtual machines. In another implementation, a cloud hosts one or more components of the telematics data-based driving assessment platform 102. The server device(s) 128 may represent an instance among large instances of application servers in a cloud computing environment, a data center, or other computing environment. The server device(s) 128 can access data stored at one or more database(s) 122 (e.g., including any of the data, values, and associations discussed herein, such as driving attributes of connected user(s) 132 stored in the one or more databases 122). The server device(s) 128 can compare the driving attribute(s) 104 to driving attributes of connected user(s) 132 retrieved from the one or more database(s) 122 and generate data to send to the telematics device to cause the comparison to be displayed on a display of the vehicle 106 and/or the one or more mobile computing devices 110.

The telematics data-based driving assessment platform 102 executing on the server device(s) 128, and/or other resources connected to the network(s) 130, may access one or more other servers to access other websites, applications, web services interfaces, storage devices, APIs, computing devices, or the like to perform the techniques discussed herein. For instance, one server (e.g., a third-party server, a vendor server, a remote server, etc.) can receive and aggregate the telematics data 108. This server can perform the analytics discussed herein on the telematics data 108 to generate driving attribute(s) 104, which can then be transmitted to a second server. The second server can compare the driving attribute(s) 104 to driving attributes of connected user(s) 132 retrieved from the one or more database(s) 122 and generate data to send to the telematics device to cause the comparison to be displayed on a display of the vehicle 106 and/or the one or more mobile computing devices 110.

For instance, the telematics data-based driving assessment platform 102 executing on the server device(s) 128 can perform analytical operations to generate the driving attributes 104 for the vehicle 106 and/or the specific individual 112. In some instances, the telematics data-based driving assessment platform 102 uses the telematics data 108 to determine or generate the one or more driving attributes 104 corresponding to the specific individual 112, the vehicle 106, and/or one or more additional vehicle operators associated with the specific individual 112 and/or the vehicle 106. The driving attributes 104 can then be compared to driving attributed of connected user(s) 132 that are stored on the one or more database(s) 122 and generate data to send to the telematics device to cause the comparison to be displayed on a display of the vehicle 106 and/or a display of the one or more mobile computing devices 110.

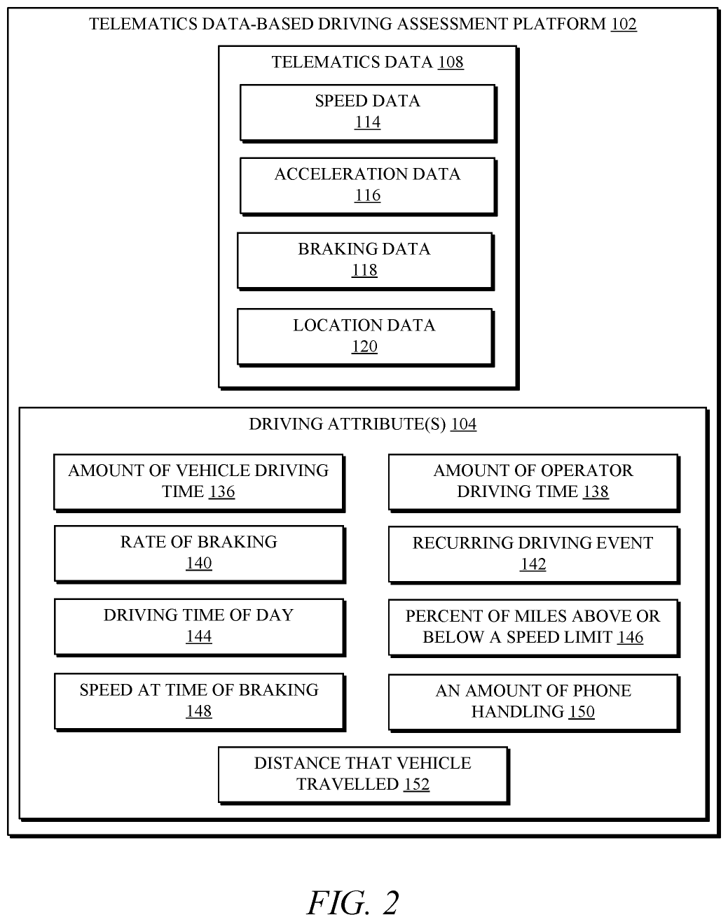

Moreover, various data types discussed herein can be presented at a user interface (UI) 134. In some instances, a user input at the UI 134 can be received by the telematics data-based driving assessment platform 102 indicating, for instance, that the specific individual 112 is or would like to use the services of the telematics data-based driving assessment platform 102. Furthermore, the telematics data-based driving assessment platform 102 can receive the telematics data 108 (e.g., from a vehicle connection and a mobile connection, respectively) and can aggregate this data for comparison with the driving attributes of connected user(s) 132. The network 130 connecting these components, so that the data can be transmitted on the backend, can also provide a frontend user experience. For instance, the driving attributes 104 and/or the comparison of the driving attributes 104 with the driving attributes of connected user(s) 132 can be presented at the UI 134 in an easily digestible format to encourage safe driving behavior. The UI 134 can also allow the user to select which driving attributes 104 and/or the comparison of the driving attributes 104 with the driving attributes of connected user(s) 132 are to be displayed. These and various other operations are discussed in greater detail below regarding FIGS. 2-4.

FIG. 2 illustrates the telematics data based driving assessment platform 102 to assess driving behavior using different types of telematics data to generate the driving attribute(s) 104. The different types of telematics data can include acceleration data 114, braking data 116, location data 118, speed data 120, and combinations thereof. Using combinations of the different types of telematics data, the telematics data-based driving assessment platform 102 can generate the driving attributes 104, which can correspond to the specific individual 112, the vehicle 106, additional plurality of vehicle operators, and/or combinations thereof.

The telematics data-based driving assessment platform 102 can generate the driving attributes 104 by weighing, combining, and performing other analytical techniques on the telematics data 108. For instance, the telematics data-based driving assessment platform 102 can determine an amount of vehicle driving time 136 corresponding to the vehicle 106 using the telematics data 108 (e.g., using timestamps for vehicle activity on which any of the aforementioned data types are based). An amount of operator driving time 138 can be determined from the telematics data 108 corresponding to the specific individual 112 and/or the one or more additional vehicle operators. For instance, the telematics data-based driving assessment platform 102 can aggregate the operator driving time 138 for the specific individual 112 by determining times that the specific individual 112 is operating the vehicle 106.

Furthermore, the telematics data-based driving assessment platform 102 can determine other driving attributes 104 that can correspond to the vehicle 106, the specific individual 112, the one or more additional vehicle operators, or any combinations thereof. These driving attributes 104 can include a rate of braking 140 determined by detecting and/or averaging one or more deceleration events; a recurring driving event 142 determined by detecting a repeating driving pattern on an hourly, daily, weekly, or monthly basis; a driving time of day 144 which can include an average driving time of day over many driving events or a particular driving time of day for a particular driving event; a percent of miles above or below a speed limit 146 (e.g., determined over a predetermined amount of time); a speed at time of braking 148 (e.g., based on the speed data 120); an amount of phone handling 150 (e.g., based on detecting phone usage activity occurring while driving); and/or a distance that the vehicle travelled 152.

In some examples, various driving attributes 104 can be associated together (e.g., based on matching corresponding timestamps) and/or associated with other information accessible to the telematics data-based driving assessment platform 102 to create other, more advanced driving attributes 104. This can provide additional information on which the comparison with the driving attributes of connected users 132 can be based. For instance, the telematics data-based driving assessment platform 102 can determine the rate of braking 140 associated with the speed at the time of braking 148; the driving time of day 144 associated with the recurring driving event 142; the percent of miles above or below the speed limit 146 associated with the driving time of day 144; the percent of miles above or below the speed limit 146 associated with a population density of an area being driven through; a driving speed (e.g., the speed, such as, for example, 80 miles per hour, at time of braking 148) associated with the driving time of day 144; the driving speed (e.g., the speed at time of braking 148) associated with the population density of the area being driven through; the rate of braking 140 associated with the distance that the vehicle travelled 152 (e.g., hard braking per 100 miles); the driving time of day 144 associated with the distance that the vehicle travelled 152 (e.g., miles driven during risky time periods) and combinations thereof. In addition, the distance that the vehicle travelled 152 can be aggregated to determine driving miles per trip, annual driving miles, etc. As such, the telematics data-based driving assessment platform 102 can generate a more complete, sophisticated, and personalized driving assessment for the specific individual 112 operating the vehicle 106.

In an implementation, the telematics data-based driving assessment platform 102 can analyze the driving attributes 104 to determine trends, such as, for example, time of day that the vehicle 106 is driven, average distance and/or time that vehicle is driven 106, average percent of miles above or below speed limit, etc. The trends can be displayed on a display of the telematic device. In one implementation, a user can manipulate the display to show only desired trends. In one implementation, the driving attributes 104 can communicate with the telematics device to cause the telematics device to generate a notification to be displayed on a display of the telematic device indicating when trends have changed (e.g., the specific individual 112 did not drive and/or the vehicle 106 was not driven for a period of time, the vehicle 106 was driving during a time of day that is not typical, the average percent of miles above a speed limit is exceeded, etc.).

The telematics data-based driving assessment platform 102 can also compare the driving attributes 104 corresponding to the vehicle 106, the specific individual 112, and/or the one or more additional vehicle operators with driving attributes of connected user(s) 132. In some instances, a statistical average of the driving attributes of connected user(s) 132 is determined by the telematics data-based driving assessment platform 102 during a data aggregation process prior to the comparing operation. In another implementation, a normal distribution is determined by the telematics data-based driving assessment platform 102 for the driving attributes of connected user(s) 132 for comparing with the driving attributes 104. In another implementation, the statistical average of the driving attributes of connected user(s) 132 is determined prior to be received by the telematics data-based driving assessment platform 102. Result(s) of the comparing can then be displayed on the display of the telematics device.

Turning to FIG. 3, a system 300 to display driving data using telematics data can include one or more computing device(s) 302 for performing the techniques discussed herein. In one implementation, the one or more computing device(s) 302 include the server device(s) 128 the telematics device disposed in the vehicle 106, the computing device of the vehicle 106, the mobile computing device 110 and/or other computing devices associated with the vehicle 106, the specific individual 112, the additional vehicle operator(s), and/or an insurance provider to generate and execute the telematics data-based driving assessment platform 102 as a software application and/or a module or algorithmic component of software.

In some instances, the computing device(s) 302 (e.g., the telematics device, such as the mobile computing device 110, the computing device of the vehicle 106, etc.) can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device(s) 302 may be integrated with, form a part of, or otherwise be associated with the systems 100-300. It will be appreciated that specific implementations of these devices may be of differing possible specific computing architectures not all of which are specifically discussed herein but will be understood by those of ordinary skill in the art.

The computing device 302 may be a computing system capable of executing a computer program product to execute a computer process. Data and program files may be input to the computing device 302, which reads the files and executes the programs therein. Some of the elements of the computing device 302 include one or more hardware processors 304, one or more memory devices 306, and/or one or more ports, such as input/output (IO) port(s) 308 and communication port(s) 310. Additionally, other elements that will be recognized by those skilled in the art may be included in the computing device 302 but are not explicitly depicted in FIG. 3 or discussed further herein. Various elements of the computing device 302 may communicate with one another by way of the communication port(s) 310 and/or one or more communication buses, point-to-point communication paths, or other communication means.

The processor 304 may include, for example, a central processing unit (CPU), a microprocessor, a microcontroller, a digital signal processor (DSP), and/or one or more internal levels of cache. There may be one or more processors 304, such that the processor 304 comprises a single central-processing unit, or a plurality of processing units capable of executing instructions and performing operations in parallel with each other, commonly referred to as a parallel processing environment.

The computing device 302 may be a conventional computer, a distributed computer, or any other type of computer, such as one or more external computers made available via a cloud computing architecture. The presently described technology is optionally implemented in software stored on the data storage device(s) such as the memory device(s) 306, and/or communicated via one or more of the I/O port(s) 308 and the communication port(s) 310, thereby transforming the computing device 302 in FIG. 3 to a special purpose machine for implementing the operations described herein and generating the. Moreover, the computing device 302, as implemented in the systems 100-300, receives various types of input data (e.g., the telematics data 108) and transforms the input data through various stages of the data flow into new types of data files (e.g., the driving attributes 104) Moreover, these new data files are transformed further into instructions that are sent to the telematics device to cause the comparison of the driving attribute(s) 104 to driving attributes of connected user(s) 132 retrieved from the one or more database(s) 122 to be displayed on a display of the vehicle 106 and/or the one or more mobile computing devices, which enables the computing device 302 to do something it could not do before-generate a user interface comparing the driving attribute(s) 104 of the vehicle 106 and/or the specific individual 112 to driving attributes of connected user(s) 132 to encourage safe driving behavior of the operator of the vehicle 106.

Additionally, the systems and operations disclosed herein represent an improvement to the technical field of vehicle telematics and sensor verification. For instance, the telematics data-based driving assessment platform 102 can provide for the usage of more granular data across different data sources, and with built in redundancies, such that more advanced driving attributes 104 can be calculated, and with improved accuracy (e.g., a reduced error range). Moreover, data can be leveraged from different data sources with varying levels of abstraction to provide a highly customized comparison, while improving transparency to the end user (e.g., via presentation of the various calculations and comparisons at the UI 134). These techniques are rooted in technology and could not have existed prior to the advent of vehicle telematics and/or sensor data analytics.

The one or more memory device(s) 306 may include any non-volatile data storage device capable of storing data generated or employed within the computing device 302, such as computer executable instructions for performing a computer process, which may include instructions of both application programs and an operating system (OS) that manages the various components of the computing device 302. The memory device(s) 306 may include, without limitation, magnetic disk drives, optical disk drives, solid state drives (SSDs), flash drives, and the like. The memory device(s) 306 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 306 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 302 includes one or more ports, such as the I/O port(s) 308 and the communication port(s) 310, for communicating with other computing, network, or vehicle computing devices. It will be appreciated that the I/O port 308 and the communication port 310 may be combined or separate and that more or fewer ports may be included in the computing device 302.

The I/O port 508 may be connected to an I/O device, or other device, by which information is input to or output from the computing device 302. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 302 via the I/O port 308. Similarly, the output devices may convert electrical signals received from the computing device 302 via the I/O port 308 into signals that may be sensed as output by a human, such as sound, light, and/or touch. The input device may be an alphanumeric input device, including alphanumeric and other keys for communicating information and/or command selections to the processor 304 via the I/O port 308. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 302 via the I/O port 308. For example, an electrical signal generated within the computing device 302 may be converted to another type of signal, and/or vice-versa. In one implementation, the environment transducer devices sense characteristics or aspects of an environment local to or remote from the computing device 302, such as, light, sound, temperature, pressure, magnetic field, electric field, chemical properties, physical movement, orientation, acceleration, gravity, and/or the like.

In one implementation, the communication port 310 is connected to the network 130 so the computing device 302 can receive network data useful in executing the methods and systems set out herein as well as transmitting information and network configuration changes determined thereby. Stated differently, the communication port 310 connects the computing device 302 to one or more communication interface devices configured to transmit and/or receive information between the computing device 302 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 310 may communicate with an antenna or other link for electromagnetic signal transmission and/or reception.

In an example, the telematics data-based driving assessment platform 102, and/or other software, modules, services, and operations discussed herein may be embodied by instructions stored on the memory devices 306 and executed by the processor 304.

The system set forth in FIG. 3 is but one possible example of a computing device 302 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 302.

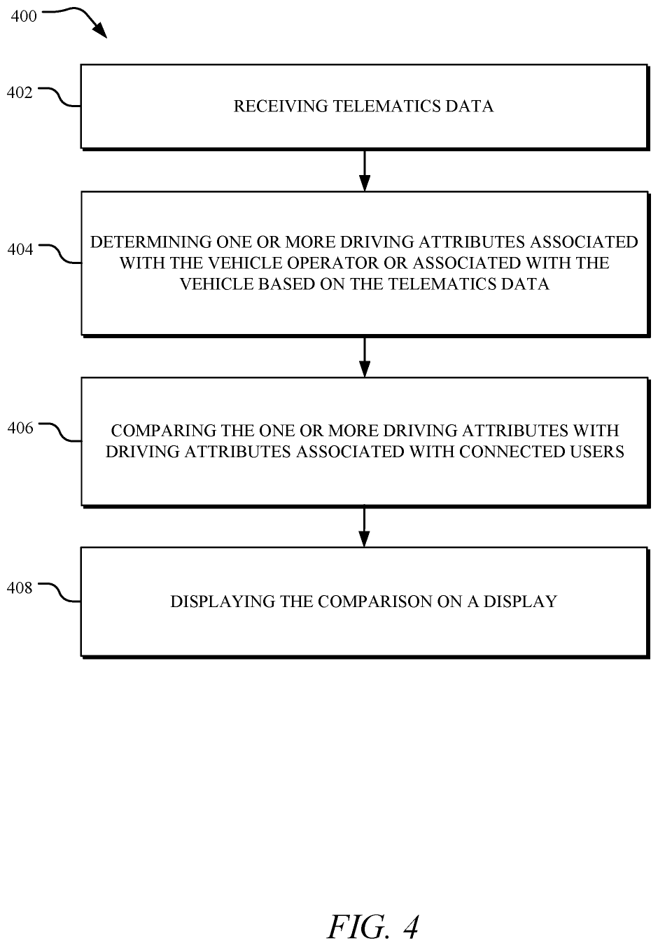

FIG. 4 depicts an example method 400 to display driving data using different types of telematics data, which can be performed by any of the systems 100-300 discussed herein.

At operation 402, the method 400 can receive telematics data 108 generated using a telematics device disposed within a vehicle 106, such as a mobile computing device 110 or a computing device of the vehicle 106. At operation 404, the method 400 can determine one or more driving attributes 104 associated with an operator of the vehicle, such as the specific individual 112, and/or associated with the vehicle 106 based on the telematics data 108. At operation 406, the method 400 can compare the one or more driving attributes 104 with driving attributes associated with connected user(s) 132. At operation 408, the method 400 can generate data to cause the comparison to be displayed on a display of the telematics device, such as, for example, a display of the vehicle 106 and/or the UI 134 of the mobile computing device 110.

It is to be understood that the specific order or hierarchy of operations in the methods depicted in FIG. 4 and throughout this disclosure are instances of example approaches and can be rearranged while remaining within the disclosed subject matter. For instance, any of the operations depicted in FIG. 4 may be omitted, repeated, performed in parallel, performed in a different order, and/or combined with any other of the operations depicted in FIG. 4 or discussed herein.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A computer implemented method comprising:
receiving telematics data generated by a telematics device disposed within a vehicle;
determining one or more driving attributes associated with the vehicle based on the telematics data;
comparing the one or more driving attributes associated with the vehicle with one or more driving attributes associated with one or more connected users, the one or more driving attributes associated with one or more connected users received from one or more databases; and
generating data to cause a user interface to be generated presenting a result of the comparing.

2. The method of claim 1, wherein the telematics device is a computing device of the vehicle.

3. The method of claim 2, wherein the telematics device is an on-board diagnostics device installed at the vehicle.

4. The method of claim 1, wherein the telematics device is a mobile computing device.

5. The method of claim 1, wherein:
the telematics data generated by the telematics device includes:
speed data;
acceleration data;
braking data; and
location data.

6. The method of claim 1, wherein the one or more driving attributes include one or more of:
an amount of vehicle driving time;
an amount of operator driving time;
a rate of braking;
a driving speed at a time of braking;
a driving time of day;
a recurring driving event;
a percent of miles above or below a speed limit;
distance that the vehicle travelled; and
an amount of phone handling.

7. The method of claim 1, further comprising:
determining one or more trends of the one or more driving attributes; and
causing the user interface to present a notification indicating that the one or more trends have changed.

8. The method of claim 1, wherein the comparing the one or more driving attributes associated with the vehicle to the one or more driving attributes associated with one or more connected users includes comparing the one or more driving attributes associated with the vehicle to a statistical average of the one or more driving attributes associated with one or more connected users.

9. The method of claim 1, wherein the comparing the one or more driving attributes associated with the vehicle to the one or more driving attributes associated with one or more connected users includes comparing the one or more driving attributes associated with the vehicle to a normal distribution of the one or more driving attributes associated with one or more connected users.

10. A system comprising:
at least one processor configured to:
determine telematics data generated using a telematics device disposed within a vehicle;
determine one or more driving attributes associated with at least one of a vehicle operator or the vehicle based on the telematics data;
compare the one or more driving attributes associated with the at least one of the vehicle operator or the vehicle to one or more driving attributes associated with one or more connected users, the one or more driving attributes associated with one or more connected users received from one or more databases; and
cause a user interface to be generated that presents a result of the comparison.

11. The system of claim 10, wherein the one or more driving attributes include a rate of braking associated with a distance that the vehicle travelled.

12. The system of claim 10, wherein the one or more driving attributes include a driving time of day associated with a distance that the vehicle travelled.

13. The system of claim 10, wherein the one or more driving attributes include a driving speed associated with a distance that the vehicle travelled.

14. The system of claim 10, wherein the at least one processor is further configured:
determine one or more trends of the one or more driving attributes; and
cause the user interface to present a notification indicating that the one or more trends have changed.

15. The system of claim 10, wherein the telematics device is one of a computing device of the vehicle or a mobile computing device.

16. The system of claim 10, wherein the one or more driving attributes associated with the at least one of the vehicle operator or the vehicle are compared with a statistical average of the one or more driving attributes associated with one or more connected users.

17. One or more tangible non-transitory computer-readable storage media storing computer-executable instructions for performing a computer process on a computing system, the computer process comprising:
receiving telematics data generated by a telematics device disposed within a vehicle;
determining one or more driving attributes associated with a specific individual operating the vehicle based on the telematics data;
comparing the one or more driving attributes associated with the specific individual operating the vehicle to one or more driving attributes associated with one or more connected users, the one or more driving attributes associated with one or more connected users received from one or more databases; and
causing a user interface to be generated presenting a result of the comparing.

18. The one or more tangible non-transitory computer-readable storage media storing computer-executable instructions for performing the computer process on the computing system of claim 17, wherein the one or more driving attributes associated with the specific individual operating the vehicle include:
an amount of driven miles associated with the vehicle; and
a driving speed associated with the specific individual.

19. The one or more tangible non-transitory computer-readable storage media storing computer-executable instructions for performing the computer process on the computing system of claim 17, wherein the computer process further comprises:
determining one or more trends of the one or more driving attributes; and
causing the user interface to present a notification indicating that the one or more trends have changed.

20. The one or more tangible non-transitory computer-readable storage media storing computer-executable instructions for performing the computer process on the computing system of claim 17, wherein the comparing the one or more driving attributes associated with the specific individual operating the vehicle to the one or more driving attributes associated with one or more connected users includes comparing the one or more driving attributes associated with the specific individual operating the vehicle to a normal distribution of the one or more driving attributes associated with one or more connected users.
